(19) United States
(12) Patent Application Publication
(10) Pub. No.: US 2005/0133697 A1
(43) Pub. Date: Jun. 23, 2005

(54) Sensor devices containing co-polymer substrates for analysis of chemical and biological species in water and air

(76) Inventors: Radislav Alexandrovich Potyrailo, Niskayuna, NY (US); Patrick Joseph McCloskey, Watervliet, NY (US); Narayan Ramesh, Evansville (IN); Cheryl Margaret Surman, Albany, NY (US)

Correspondence Address: GE Global Research;Docket Room K-1/4A59, One Research Circle, Niskayuna, NY, 12309, US

(21) Appl. No.: 10/745,140

(22) Filed: Dec. 23, 2003

(51) Int. Cl. H01J 3/14; G01N 27/26

(52) U.S. Cl. 250/216; 204/400

(57) ABSTRACT

Sensor devices are disclosed possessing substrates having enhanced resistance to solvents. The sensor device (10) has a sensor region (12) deposited on a substrate (14). In optional embodiments, a protecting layer (16) is applied over the sensor region. The substrates include polycarbonates combined with solvent resistance-imparting monomers that result in a copolycarbonate substrate immune to attack by organic solvents commonly used in sensor deposition and improve the quality of the deposited sensor regions.

### BACKGROUND OF THE INVENTION

This disclosure is directed to support materials, i.e., substrates, and methods for sensor deposition that provide sensors possessing improved optical quality and stability. These new properties are achieved utilizing different polycarbonate copolymers as sensor substrates. These polycarbonate copolymers are immune to attack by organic solvents commonly used in sensor deposition and improve the quality of the deposited sensor regions.

In chemical sensor devices, an analyte-responsive reagent is typically incorporated into a support matrix such as a polymer, sol-gel, biomembrane, or similar material. See, e.g., Yang, et al., “Chemical Sensing Using Sol-gel Derived Planar Waveguides and Indicator Phases”, Anal. Chem. 1995, 67, 1307-1314; Potyrailo, et al., “Optical Waveguide Sensors in Analytical Chemistry: Today's Instrumentation, Applications and Future Development Trends”, Fresenius' J. Anal. Chem. 1998, 362, 349-373; Potyrailo, et al., “Adapting Selected Nucleic Acid Ligands (Aptamers) to Biosensors”, Anal. Chem. 1998, 70, 3419-3425. Such incorporation is performed by preparing a sensor-material solution that contains a reagent, a dissolved matrix, at least one common solvent, and other additional components, such as ionophores, plasticizers, etc. See, Bakker, et al., “Selectivity of Ion-sensitive Bulk Optodes”, Anal. Chem. 1992, 64, 1805-1812; Bakker, et al., “Detection Limit of Ion-selective Bulk Optodes and Corresponding Electrodes”, Anal. Chim. Acta 1993, 282, 265-271. The solution containing the sensor material is then deposited on a suitable substrate to form a sensor.

However, solvents commonly used for preparation of the sensor solution can negatively impact the substrate during sensor deposition. These effects can include a change in surface morphology, crystallinity, transparency, geometrical size and shape, and other similar properties of the sensor which, in turn, can adversely affect the analytical capacity of the sensor. In particular, two types of problems are common with the use of solvents. First, a solvent of the sensor solution can attack the plastic substrate and distort one or more substrate properties which, in many cases, are critical for sensor functionality. For example, if transparency is reduced because of solvent-induced haze, transmission optical measurement results will contain errors. Similarly, if the substrate is to function as a waveguide, the distortion of geometrical shape by the solvent can lead to critical errors. Thus, the wave-guiding capability will be reduced or lost. The second problem which can arise with solvents is with respect to how the solvent interacts with the substrate. The dissolved substrate material can negatively affect the sensor solution composition adding to the loss of desired signal after the sensor layer has formed.

One method to overcome these problems involves the use of ion-selective membranes, which can be fabricated separately and attached to a microfluidic system using an adhesive tape to form a sensor. See, Johnson, et al., “Development of a Fully Integrated Analysis System for Ions Based on Ion-selective Optodes and Centrifugal Microfluidics”, Anal. Chem. 2001, 73, 3940-3946; Badr, et al., “Fluorescent Ion-selective Optode Membranes Incorporated Onto a Centrifugal Microfluidics Platform”, Anal. Chem. 2002, 74, 5569-5575. However, this approach is complicated and reduces the reproducibility of measurements obtained.

In long-term sensor applications, it is often important that the matrix component of the sensor does not induce leaching of the reagent or other small-molecule components. One method utilized to minimize this from occurring involves covalent attachment of reagents to a polymer matrix. See Baldini, et al., “Analysis of Acid-base Indicators Covalently Bound on Glass Supports”, Proc. SPIE-Int. Soc. Opt. Eng., 1368 (Chemical, Biochemical, and Environmental Fiber Sensors II) 210-217 (1990); Brennan, et al., “Covalent Immobilization of Amphiphilic Monolayers Containing Urease Onto Optical Fibers for Fluorimetric Detection of Urea”, Sens. Actuators B 1993, 11, 109-119; Crowther, et al., “Covalent Immobilisation of Solvatochromic Dyes”, J. Chem. Soc., Chem. Commun. 1995, 2445; Rao, et al., “Preparation of pH Sensors by Covalent Linkage of Dye Molecules to the Surface of Polystyrene Optical Fibers”, J. Appl. Polymer Sci. 1991, 43, 925-928; U.S. Pat. No. 5,182,353; U.S. Pat. No. 5,015,715; Wang, et al., “Comparison Between Covalent Attachment and Physisorption of 2-(p-toluidinyl)naphthalene-6-sulfonate (TNS) to Proteins”, Appl. Spectrosc. 1993, 47, 800-806; Weigl, et al., “Chemically and Mechanically Resistant Carbon Dioxide Optrode Based on a Covalently Immobilized pH Indicator”, Anal. Chim. Acta 1993, 282, 335-343.

Methods for the production of polycarbonates are known to those skilled in the art and include those disclosed in U.S. Pat. Nos. 6,548,623 and 5,717,056. Such polycarbonates include Lexan® (General Electric Company, Niskayuna, N.Y.), a polymer made through coupling bisphenol-A molecules through carbonate linkages. Lexan® has a relatively high glass transition temperature, great clarity and excellent ductility. However, there are applications where better resistance to one or more organic reagents is required. One such application is in the formation of sensors, which also require enhanced adherence of the sensor material.

Methods for improving the adherence of materials to substrates are known in the art and include the use of adhesion promoting agents as disclosed in U.S. Pat. No. 5,093,161, and ink jet systems for applying materials to substrates as disclosed in U.S. Pat. No. 6,506,438.

Efforts to produce more solvent resistant polymers while retaining the essential optical characteristics and ductility are ongoing. There is especially a need for the development of new materials and deposition strategies that reduce the undesirable effects of solvents on the substrates during sensor material deposition.

### BRIEF DESCRIPTION OF THE INVENTION

The present disclosure is directed to sensor devices comprising a substrate comprising a polycarbonate combined with at least one solvent resistance-imparting monomer and a sensor region comprising an analyte-responsive reagent having a predetermined response upon exposure to an analyte of interest. In some embodiments the sensor region covers a discrete area of the substrate.

In one embodiment, the at least one solvent resistance-imparting monomer is selected from the group consisting of hydroquinone, methylhydroquinone, and resorcinol. The addition of the solvent resistance-imparting monomer results in a copolycarbonate substrate resistant to degradation by solvents used to deposit sensor regions on the substrate, including nonpolar organic solvents such as tetrahydrofuran (THF), methyl ethyl ketone (MEK), hexafluoro ethanol, chlorobenzene, and any chlorinated hydrocarbons such as methylene chloride, chloroform, dichloroethene, and others.

### BRIEF DESCRIPTION OF THE DRAWINGS

FIG. 1 is a depiction of embodiments of the solvent-resistant substrates of the present disclosure for sensor applications.

FIG. 2 is a depiction of an experimental set-up utilizing an array having a 6×4 configuration for evaluation of solvent/polymer permutations. FIG. 2A shows the plate layout for evaluation of 6×4 polymer/solvent permutations. FIG. 2B is a conceptual response of the high-throughput system for evaluation of solubility amount and rate.

FIG. 3 is a graph of the results of the high-throughput solubility experiments measuring sensor signal over time for the various materials tested in Example 1. Several types of polycarbonate copolymers were exposed to the same solvent (chloroform). In this experiment, the 6×4 array was periodically immersed in the solvents and the frequency change was measured upon solvent evaporation.

FIG. 4 are graphs demonstrating the reproducibility of the polymer solubility determinations, plotting sensor signal versus time for the materials tested in Example 1. Six different polymers with four replicate solvent/polymer solutions were analyzed. The error bars for each data point indicate one standard deviation from the mean of four measurements obtained from individual crystals. Discrimination ability is depicted for highly soluble (FIG. 4A) and low soluble (FIG. 4B) polymers.

FIG. 5 is a graph plotting normalized fluorescence of solvatochromic dye nile red versus wavelength demonstrating the effects of solvent on different polycarbonates with different molecular weights and polycarbonate copolymers.

FIG. 6 is a graph plotting normalized fluorescence of solvatochromic dye nile red versus wavelength demonstrating the effects of solvent on different polycarbonates with different molecular weights and polycarbonate copolymers.

FIG. 7 is a graph plotting normalized fluorescence of solvatochromic dye nile red versus wavelength demonstrating the effects of solvent on different polycarbonates with different molecular weights and polycarbonate copolymers, utilizing glass as a control.

FIG. 8 is a picture of treated sensors demonstrating the effects of solvent on different polycarbonates with different molecular weights, copolymers, and glass slide (used as control). Sensor regions were a pH sensitive composition (bromocresol green in cellulose acetate). FIG. 8(1) shows substrates in water of low pH. FIG. 8(2) shows substrates in water with high pH. The exposure time for both was 3 minutes.

FIG. 9 is a picture of treated sensor substrate with pH reagent immobilized in a cellulose acetate film deposited onto a polycarbonate copolymer material upon immersion in solutions of low pH (FIG. 9A) and high pH (FIG. 9B).

FIG. 10 is a graph of absorbance versus wavelength depicting spectral properties of the pH reagent immobilized in a cellulose acetate film deposited onto a polycarbonate copolymer material upon immersion in solutions of low and high pH.

FIG. 11 is a graph of absorbance versus time depicting the stability of the immobilized reagent over time in solutions of low and high pH.

FIG. 12 is a picture of sensors made with various substrates depicting the stability of sensor regions (bromocresol green in cellulose acetate, deposited from THF solution) on different substrates upon long exposure to high pH.

FIG. 13 is an electronic UV-visible absorption spectra of a polycarbonate control and several polycarbonate copolymer materials produced in accordance with the present disclosure.

### DETAILED DESCRIPTION OF THE INVENTION

The present invention may be understood more readily by reference to the following detailed description of preferred embodiments of the invention and the examples included herein. In the following specification and the claims which follow, reference will be made to a number of terms which shall be defined to have the following meanings.

The singular forms “a”, “an” and “the” include plural references unless the context clearly dictates otherwise.

“Optional” or “optionally” means that the subsequently described event or circumstance may or may not occur, and that the description includes instances where the event occurs and instances where it does not.

As used herein the term “polycarbonate” refers to polycarbonates incorporating structural units derived from one or more dihydroxy aromatic compounds and includes copolycarbonates and polyester carbonates.

As used herein, the term “melt polycarbonate” refers to a polycarbonate made by the transesterification of a diaryl carbonate with a dihydroxy aromatic compound.

“BPA” is herein defined as bisphenol A or 2,2-bis(4-hydroxyphenyl)propane.

The terms “bisphenol”, “diphenol” and “dihydric phenol” as used herein are synonymous.

As used herein the terms “aliphatic” and “aliphatic radical” are used interchangeably and refer to a radical having a valence of at least one comprising a linear or branched array of atoms which is not cyclic. The array may include heteroatoms such as nitrogen, sulfur and oxygen or may be composed exclusively of carbon and hydrogen. Examples of aliphatic radicals include methyl, methylene, ethyl, ethylene, hexyl, hexamethylene and the like.

As used herein the terms “aromatic” and “aromatic radical” are used interchangeably and refer to a radical having a valence of at least one comprising at least one aromatic group. Examples of aromatic radicals include phenyl, pyridyl, furanyl, thienyl, naphthyl, phenylene, and biphenyl. The term includes groups containing both aromatic and aliphatic components, for example a benzyl group.

As used herein the terms “cycloaliphatic radical” and “alicyclic radical” are used interchangeably and refer to a radical having a valance of at least one comprising an array of atoms which is cyclic but which is not aromatic. The array may include heteroatoms such as nitrogen, sulfur and oxygen or may be composed exclusively of carbon and hydrogen. Examples of cycloaliphatic radicals include cyclopropyl, cyclopentyl cyclohexyl, tetrahydrofuranyl and the like.

The present disclosure provides polycarbonate copolymers useful as substrates for sensor materials possessing improved surface quality after reagent deposition of the sensor on the substrate, especially when the latter is deposited in dissolved form in a typical nonpolar organic solvent.

Polycarbonates which may be prepared by the method of this invention typically comprise structural units of the formula: 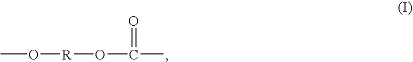
wherein at least about 60% of the total number of R groups are aromatic organic radicals and the balance thereof are aliphatic, alicyclic, or aromatic radicals. Preferably, each R is an aromatic organic radical and more preferably a radical of the formula:
-A¹-Y-A²- (II)
wherein each A¹ and A² is a monocyclic divalent aryl radical and Y is a bridging radical in which one or two carbon atoms separate A¹ and A². Such radicals are derived from dihydroxyaromatic compounds of the formulas HO—R—OH and HO-A¹-Y-A²-OH respectively. For example, A¹ and A² generally represent unsubstituted phenylene, especially p-phenylene which is preferred, or substituted derivatives thereof. The bridging radical Y is most often a hydrocarbon group and particularly a saturated group such as methylene, cyclohexylidene, or isopropylidene which is preferred. In one embodiment, the polycarbonates of the present disclosure are derived from 2,2-bis(4-hydroxyphenyl)propane, also known as bisphenol A (BPA).

A polycarbonate may be produced in accordance with the method of U.S. Pat. No. 6,548,623, which involves reacting an ester-substituted diaryl carbonate under melt reaction conditions with at least one dihydroxy aromatic compound in the presence of at least one source of alkaline earth ions or alkali metal ions, and an organic ammonium compound or an organic phosphonium compound or a combination thereof.

In another embodiment, a polycarbonate may be produced in accordance with the methods of U.S. Pat. No. 5,717,056, which involves the solid state polymerization of a precursor polycarbonate to an enhanced crystallinity precursor polycarbonate and a second step of polymerizing said enhanced crystallinity precursor polycarbonate in the solid state. The precursor polycarbonate may be a polycarbonate oligomer of the type produced by the first step of a melt polycarbonate process or by bischloroformate oligomer preparation followed by hydrolysis and/or endcapping and isolation.

In accordance with the present disclosure, the polycarbonate is combined with another monomer which confers solvent resistance on the resulting copolycarbonate. Such a compound is added to change the backbone structure of the polymer to achieve better solvent resistance. In one embodiment, a fraction of the bisphenol-A (BPA) molecules are replaced by one or more bisphenols such as hydroquinone (HQ), methylhydroquinone (MeHQ), and resorcinol (RES). Other compounds which may be utilized to replace a fraction of the BPA molecules include those disclosed in U.S. Pat. No. 5,324,809. Such compounds include, but are not limited to, 3-methylhydroquinone, 3-ethylhydroquinone, 3-propylhydroquinone, 3-butylhydroquinone, 3-t-butylhydroquinone, 3-phenylhydroquinone, 3-cumylhydroquinone, 2,3,5,6-tetrafluorohydroquinone and 2,3,5,6-tetrabromohydroquinone. Copolymers and terpolymers of a polycarbonate such as BPA which contain these other bisphenols have better solvent resistance while retaining the essential characteristics of the homopolymer (polycarbonate).

The amount of solvent resistance-imparting monomer to be combined with the monomer making up the polycarbonate is an effective amount to confer solvent resistance on the polycarbonate. This amount can range from about 2 mol % to about 90 mol %, more preferably from about 5 to about 70 mol %, and more preferably from about 10 to about 50 mol % of the total amount of the polycarbonate. The solvent resistance-imparting monomers are added during polymerization by methods known to those skilled in the art. Such methods include polycondensation reactions as disclosed in U.S. Pat. No. 5,324,809.

Specifically, in the step one reaction, the solvent resistance-imparting monomer and the polycarbonate are reacted at normal pressure, a temperature of 80°-250° C., preferably 100°-230° C., and most preferably 120°-190° C., and for 0-5 hours, preferably 0-4 hours, and most preferably 0-3 hours. Next, the reaction temperature is raised and the reaction between the solvent resistance-imparting monomer and the polycarbonate is carried out while placing the reaction system under a vacuum; polycondensation between the solvent resistance-imparting monomer and the polycarbonate is ultimately carried out under a vacuum of 5 mmHg or less, and preferably 1 mmHg or less, and at 240°-320° C.

The polycondensation reaction may be carried out on a continuous basis or as a batch-type reaction. The reaction apparatus used when carrying out the above reaction may be a tank-type, tube-type, or column-type apparatus.

The polycarbonates of the present disclosure may also contain branching agents which include polyhydroxy (i.e., trihydroxy or greater) compounds such as:
THPE,
1,3,5-tris(2-hydroxyethyl)cyanuric acid,
4,6-dimethyl-2,4,6-tris(4-hydroxyphenyl)heptane,
2,2-bis[4-(4-hydroxyphenyl)-cyclohexyl]propane,
1,3,5-trihydroxybenzene,
1,2,3-trihydroxybenzene,
1,4-bis[bis(4-hydroxyphenyl)phenyl]benzene,
2,3,4-trihydroxyacetophenone,
2,3,4-trihydroxybenzoic acid,
2,3,4-trihydroxybenzophenone,
2,4,4′-trihydroxybenzophenone,
2′,4′,6′-trihydroxy-3-(4-hydroxyphenyl)propiophenone,
pentahydroxyflavone,
3,4,5-trihydroxypyrimidine,
3,4,5-trihydroxyphenylmethylamine,
tetrahydroxy-1,4-quinone hydrate,
2,2′,4,4′-tetrahydroxybenzophenone and
1,2,5,8-tetrahydroxyanthraquinone.

Where present, the proportion of branching agent is generally about 0.1-2.0% by weight of the polycarbonate.

The substrates of the present disclosure have enhanced resistance to solvents and thus less adverse changes in their surface morphology, crystallinity, transparency, geometric size and shape, and similar properties that are undesirable in sensor applications.

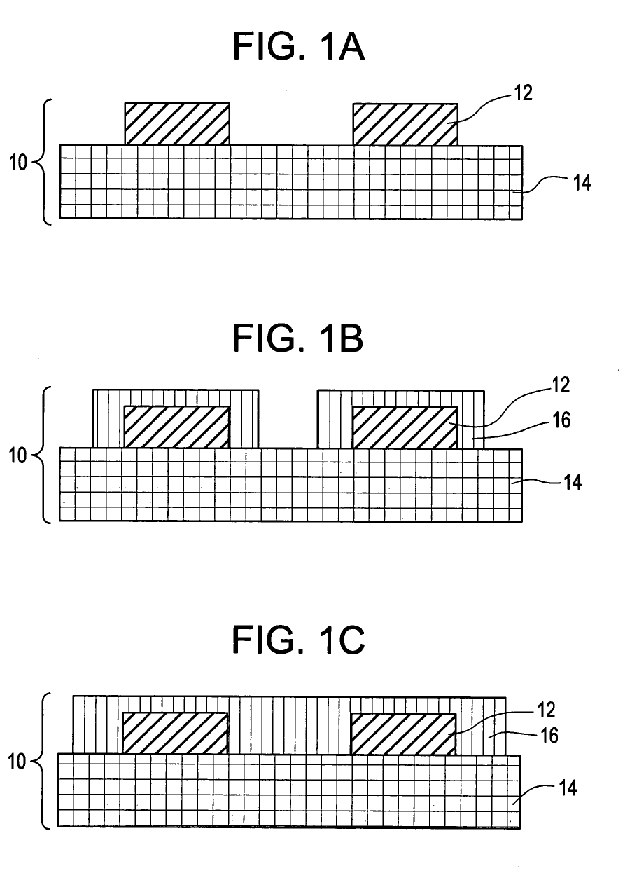

Referring now to FIG. 1A, a sensor device 10 having a sensor region 12 deposited on a copolycarbonate substrate 14 is shown. In some embodiments, the sensor region may include a discrete area on the substrate, sometimes referred to herein as a “sensor spot.” The deposition of sensor regions onto the surface of the substrate can be accomplished using any known technique such as ink-jet printing, air-brushing through a set of masks, contact printing, robotic deposition, etc.

While the sensor may be a thin film which covers the entire surface of a substrate, in one embodiment of the present disclosure discrete sensor regions or spots (12) can be deposited onto the surface of the substrate (14) as shown in FIG. 1A.

Solvents used to deposit the sensor region on the substrate can be a typical nonpolar organic solvent such as tetrahydrofuran (THF), methyl ethyl ketone (MEK), hexafluoro ethanol, chlorobenzene, and any chlorinated hydrocarbons such as methylene chloride, chloroform, dichloroethene, and others.

While such solvents will degrade conventional substrates, the substrate of the present disclosure is resistant to degradation thereby.

Several steps can be used for deposition of different components of the reagent-containing solution. Generally, these solutions are formed by mixing the components and/or applying them by natural diffusion (keeping deposition under conditions when solvent(s) do not evaporate between deposition phases). Other types of mixing known in the art are possible, for example, low-amplitude vibration, microwave mixing, etc. If needed, a polymerization step can be further applied to the composition deposited onto the substrate in one or more deposition steps.

A deposited sensor spot can be further protected by a protecting layer 16 as shown in FIGS 1B and 1C. As depicted in FIGS. 1B and 1C, the sensor region can be further protected with a protecting layer that is more resistant to water or other solvents than the sensor region. Such protecting layer can be deposited using a nonpolar solvent and/or cross-linked after deposition. Several sensor spots can be protected with different protecting layers (FIG. 1B) or the same protecting layer (FIG. 1C).

The sensing region (12) contains an analyte-responsive reagent having a predetermined response upon exposure to an analyte of interest. The analyte-responsive reagent is preferably incorporated into a support matrix such as a polymer, sol-gel, biomembrane, or similar material.

The sensor region 12 may be any material that preferably does not change the properties of the substrate 14 and, in turn, is not affected by the substrate. As such, the combination of sensor region 12 deposited on substrate 14 forms a sensor, such as an optical sensor, an acoustic wave sensor, a chemical resistor, a conductivity sensor, a micro-electro-mechanical system (MEMS) sensor, an electrochemical sensor, etc., depending upon the analyte-responsive reagent. The composition of the sensor region varies depending on the analyte being analyzed, as well as the transducer type being used. Characteristics of the sensor region, such as absorption spectrum, refractive index, luminescence intensity, luminescence lifetime, luminescence spectrum, acoustic wave properties, dielectric properties, viscoelastic properties, morphological properties, etc., may change upon exposure to analytes. Further, to enhance the ability to detect the changes or impacts on radiation, a chemically sensitive dye may be incorporated into the sensor region and optionally into the protecting layer, or a dye molecule may be directly attached to a matrix molecule. In this manner, changes of optical properties of the dye are relatable to the variation of the chemical environment.

For example, an optical sensor may include colorimetric reagents, luminescent reagents, chemiluminescent reagents, Raman reagents, surface-enhancement Raman reagents, vacuum UV absorbance reagents, UV-visible light (“UV-vis”) absorbance reagents, infrared absorbance reagents, etc. Such reagents can be in a form of an organic molecule, inorganic molecule, inorganic nanoparticle, semiconducting nanoparticle, metallic nanoparticle. Such sensors also include a Raman sensor, an interferometric sensor, a polarization sensor, a thickness-shear mode (TSM) sensor and a luminescence lifetime sensor. The interaction of sensor region 12 with an analyte may change the associated sensor property, such as the optical signature.

In another embodiment, the interaction of the analyte-responsive reagent with an analyte may alter the characteristics of received radiation, or may produce luminescent radiation, or combinations of both.

In some embodiments, the sensor region 12 may include as an analyte-responsive reagent a fluid-sensitive material, a calorimetric or fluorescent dye, a calorimetric or fluorescent dye where its optical property is modulated by presence of an analyte fluid, and combinations thereof.

The sensor region 12 is preferably a thin film, suitably of a thickness from about 0.001 to about 1000 micrometers, more preferably from about 0.005 to about 500 micrometers, and most preferably from about 0.01 to about 200 micrometers. As noted above, the substrate 14 should not interact with the sensor region 12. The substrate may include a transducer surface.

The protecting layer 16 may comprise a chemically-resistant, and preferably a solvent-resistant material, that allows an analyte to permeate to the sensor region 12. Suitable examples of a protecting layer 16 include, for example, amorphous fluoropolymers. Other types of layers depend on the nature of the substrate and sensor layers. For example, if sensing region 12 is made of a material soluble that is in water, a protecting layer 16 can be any film that is not soluble in water, yet permits an analyte of interest to reach the sensing region 12. Examples of region 12 can be a poly(vinyl alcohol) or polyvinylpyrrolidone polymer, both of which are soluble is water but can be overcoated with another polymer not soluble in water, such as poly(2-hydroxyethyl methacrylate). Poly(2-hydroxyethyl methacrylate) is a cross-linked hydrogel, it only swells upon exposure to water, but does not dissolve in water, letting ionic and other species reach the sensing region 12. Hydrogels are polymers having a large void space containing aqueous solution. Other types of hydrogels may be used and include, for example, polyacrylamide, polyurethane, poly(ethylene glycol) diacrylate, crosslinked poly(N-vinyl pyrrolidone), and poly(ethylene glycol) hydrogels.

In another embodiment, the protecting layer 16 can be a sol-gel film. Another material which may be used as protecting layer 16 can be any heavily cross-linked polymer protecting layer film, such as a polyimide. Other materials which may be used as protecting layer 16 include any polymer protecting layer film which is both inert to the sample environment and substrate. Such materials include perfluorinated ion-exchange resins commercially available as Nafion® from DuPont (Wilmington, Del.).

The substrate can be of different geometry, design, configuration, and functionality. Nonlimiting examples include flat substrates of circular, square and other shapes, cylindrical shapes such as optical fibers and their tips, grooves and channels of any microfluidic systems, and any other design that a sensor-related system can be made for. These same substrates could be attached to micro-electro-mechanical systems (MEMS) such as, but not limited to, surface acoustic wave devices, or they could be used to improve deposition properties of ionophore-containing layers in Ion Specific Field Effect Transistor (ISFET) devices. These same films could also enhance the specificity of bio-responsive agents to target analytes, but producing uniform films that more readily allow covalent linkage of antibodies, aptamers, or nucleotide sequences, to name a few.

The present disclosure is illustrated by the following non-limiting examples.

### EXAMPLE 1

Polycarbonate copolymers were used as advanced polymeric substrates for sensor applications. Compositions of these copolymers included hydroquinone, methylhydroquinone, bisphenol-A, and biphenol. A 24-channel acoustic-wave sensor system, as disclosed in U.S. patent application Ser. No. 2002/0172620 was utilized for the evaluation of the solubility of these polymers by solvents of interest. The system permitted rapid determination of minute quantities of material deposited onto the surface of a thickness-shear mode (TSM) sensor from a solvent containing a polymer of interest. A crystal was exposed to a polymer/solvent combination and a residual dissolved material was quantified after sensor removal and solvent evaporation. As the mass increase of the crystal is proportional to the amount of dissolved material, mass increase m_{F} may be detected as the change in the oscillation frequency Δf_{F} of the sensors utilizing the following equation:
Δf_{F}=−2₀²(m_{F}/A)(μ_{Q} ρ_{Q})^{-1/2},
where f₀ is the fundamental resonant frequency of an unloaded device, μ_{Q} is the shear modulus of the piezoelectric substrate, ρ_{Q} is the substrate density, m_{F} is the total mass of the coating deposited to both faces of the crystal, and A is the active surface area of one face of the crystal.

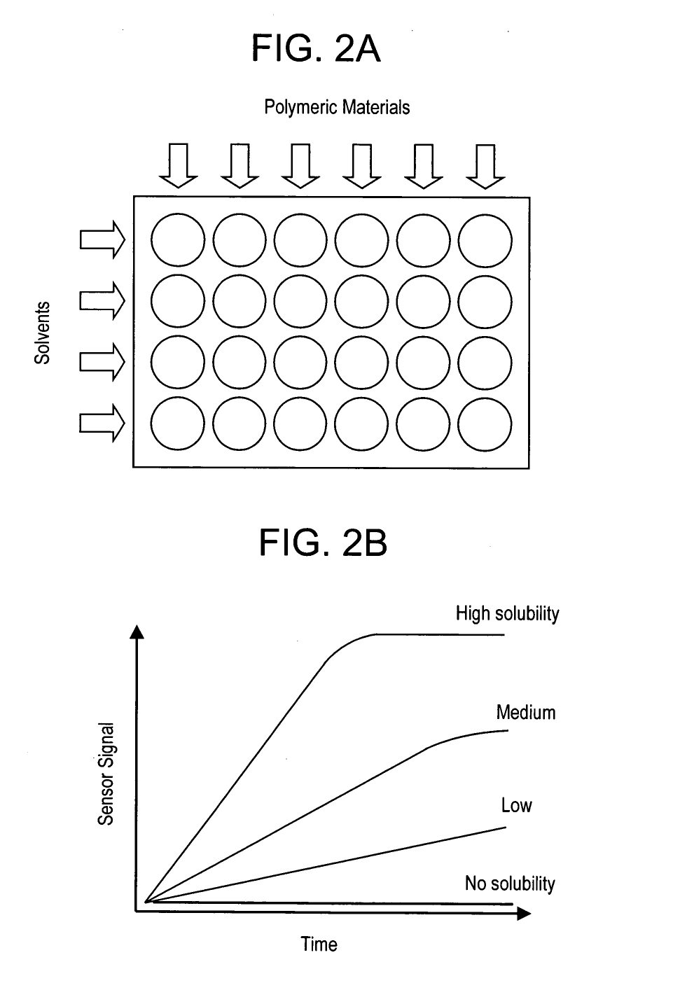

The applied 24-channel acoustic-wave sensor system was in a 6×4 configuration as depicted in FIG. 2. Thus, a variety of solvents and materials, including multiple solvent-material permutations were tested in a single experiment (FIG. 2A). Such studies were advantageous because they were done in parallel and because they reduced the variability between measurements by eliminating possible uncontrolled environmental variations that could affect individual kinetic experiments (lab temperature, atmospheric pressure, etc.). To study the solubility of the materials, measurements were performed of the dissolved amount and dissolution rate. The dissolved amount was determined by the signal of the sensor after a predetermined experimental time, while the rate was determined from the multiple measurements at different time points. As conceptually set forth in FIG. 2B, a highly soluble material should have an increased sensor signal over time; the signal intensity should be relatively less as the solubility of the material decreases.

The layout of the 24-chanel sensor system was compatible with available 24-well plates which, in turn, were derived from a 96-well microtiter plate format. In the sensor system, a printed circuit board contained 24 integrated circuit oscillators giving TTL level outputs. The oscillators were able to support oscillation frequencies of different TSM crystals in the range from ˜4 to ˜20 MHz. The 24 oscillator signals were selected one at a time using a TTL multiplexer integrated circuit and were connected to a time interval analyzer circuit card installed in a desktop personal computer. Data acquisition was achieved using a program written in LabVIEW (National Instruments, Austin, Tex.). Under the optimized data acquisition conditions, the noise of the sensor system was less than 0.1 Hz.

Solubility of several types of polycarbonate copolymers in nonpolar solvents was investigated. The polymers tested and the ratio of their components (by mol %) are set forth below in Table 1. The solvent used was chloroform.

TABLE 1
Types of studied copolymers.

| Material # | Description/mol % of components |
|---|---|
| 1 | 90/10 MeHQ/BPA |
| 2 | 80/20 MeHQ/BPA |
| 3 | 50/50 MeHQ/BPA |
| 4 | Lexan ® 125 (control) |
| 5 | 35/65 HQ/BPA |
| 6 | 20/80 HQ/BPA |

MeHQ = methylhydroquinone;
BPA = bisphenol-A;
HQ = hydroquinone

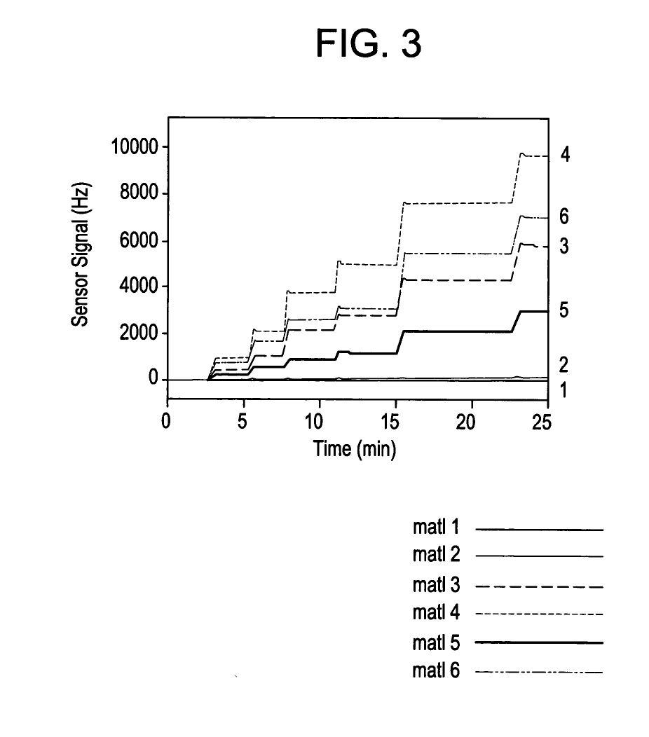

The results of the high-throughput solubility experiments are presented in FIG. 3. In each case, the copolymers were exposed to the same solvent (chloroform). In this experiment, the 6×4 array was periodically immersed into the wells and the frequency change was measured upon sensor removal from the solvent and solvent evaporation. The stable horizontal regions in the sensor responses are their signals in air upon deposition of different types of materials.

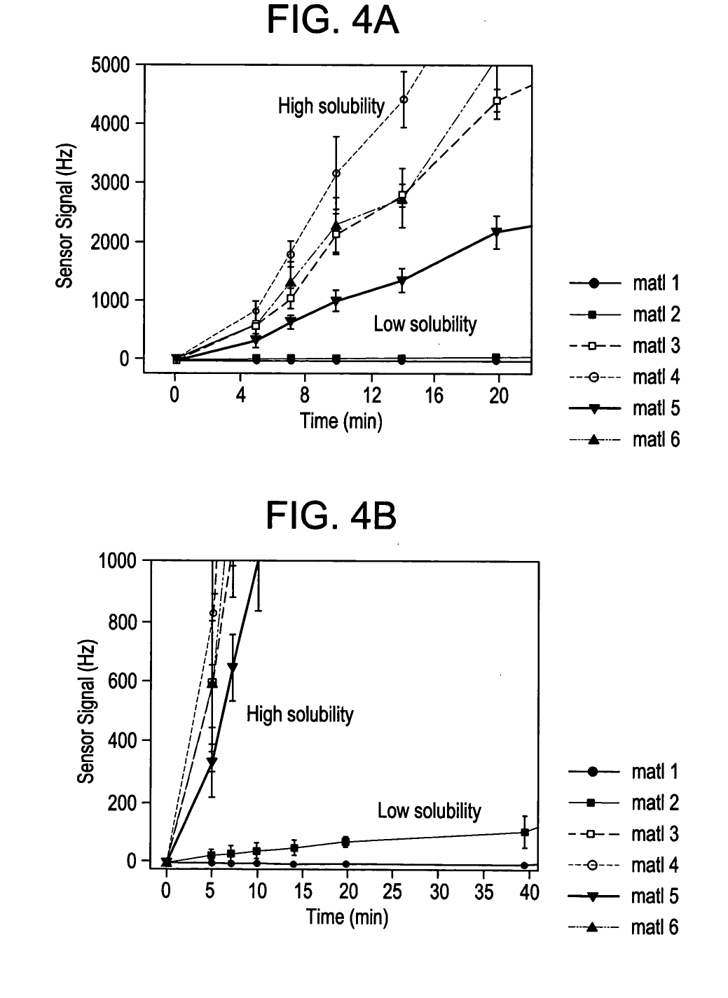

To assess the reproducibility of the determinations, four replicate solvent/polymer solutions were made for the six different polycarbonate copolymers. FIG. 4 shows the data obtained from these runs, with error bars for each data point indicating one standard deviation from the mean of four measurements obtained from individual crystals. These results indicate the simplicity and effectiveness of the system for both highly soluble (FIG. 4A) and sparingly soluble (FIG. 4B) polymers.

### EXAMPLE 2

This example compared polycarbonate copolymers and BPA polycarbonate as sensor substrates. The effects of solvents used for preparation of sensor regions was compared for different sensor substrates. Sensor substrate materials and the ratio of their components (by mol %) are set forth below in Table 2. The solvents utilized were chloroform and THF.

TABLE 2
Types of studied sensor substrates.

| Material # | Description/mol % of components |
|---|---|
| A | OQ1020C |
| B | PC 104 |
| C | PC134 |
| D | 30/20/50 HQ/RS/BPA |
| E | 80/20 MeHQ/BPA |
| F | Glass slide |

OQ1020C is an optical grade polycarbonate obtained from GE Plastics, Spain, with a Molecular Weight of about 18,000.
PC 104 and PC 134 are polycarbonates obtained from GE Plastics, The Netherlands, with Molecular Weights of about 30,000 and 35,000, respectively.
MeHQ = methylhydroquinone; BPA = bisphenol-A; HQ = hydroquinone

The comparison was done by the formation of two types of sensor regions. The first type was made by depositing a solution of nile red in chloroform (10 microL) onto the flat surface of substrate materials. The second type was made by depositing a solution of bromocresol green and cellulose acetate in THF (10 microL) onto the flat surface of substrate materials.

Sensors possessing the first type of sensor regions (nile red) were deposited to demonstrate the solubility of the substrates after a short exposure to the solvent. The nile red dye is a solvatochromic dye that changes the position of the fluorescence emission peak as a function of the local polarity of the microenvironment (See Barnard, et al., “Fiber-optic organic vapor sensor”, Environ. Sci. Technol. 1991, 25, 1301-1304). Upon rapid exposure to a solvent containing nile red, a polycarbonate copolymer with poor solvent resistance will be attacked by the solvent and nile red will be partially incorporated into the polymer. However, a polycarbonate copolymer with high solvent resistance will not be dissolved by the solvent and there will be little or no incorporation of the nile red into the polymer. By comparing the emission spectra of nile red after solvent evaporation, one can qualitatively determine the level of solvent-induced degradation of the polymer.

Measurements of fluorescence spectra of the treated substrates were conducted using a modular automatic scanning system that consisted of a laser light source and a portable spectrofluorometer. The light from the laser light source (532 nm, Nanolase, France) was focused into one of the arms of a “six-around-one” bifurcated fiber-optic reflection probe (Ocean Optics, Inc., Model R400-7-UVNVIS). Emission light was collected when the common end of the fiber-optic probe was positioned in proximity to a sample. The second arm of the probe was coupled to the portable spectrofluorometer (Ocean Optics, Inc., Model ST2000) through an in-line optical filter holder (Ocean Optics). The spectrofluorometer was equipped with a 200-μm slit, 600-grooves/mm grating blazed at 400 nm and covering the spectral range from 250 to 800 nm with efficiency greater than 30%, and a linear CCD-array detector. Data analysis was performed using KaleidaGraph software (Synergy Software, Reading, Pa.).

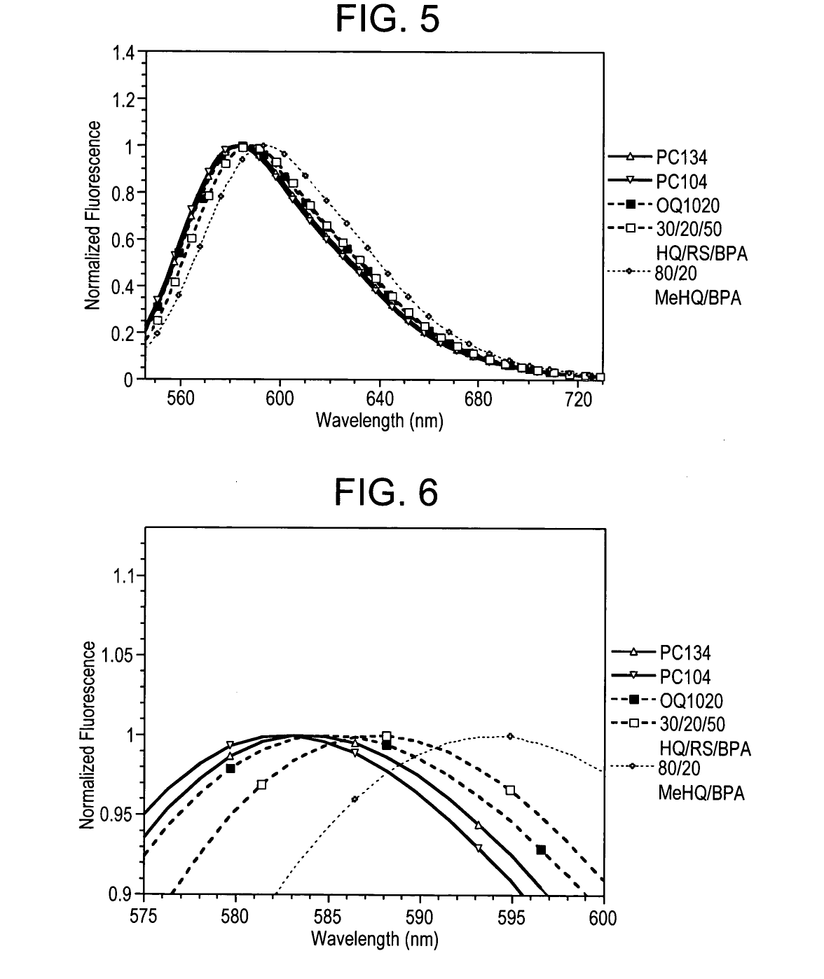

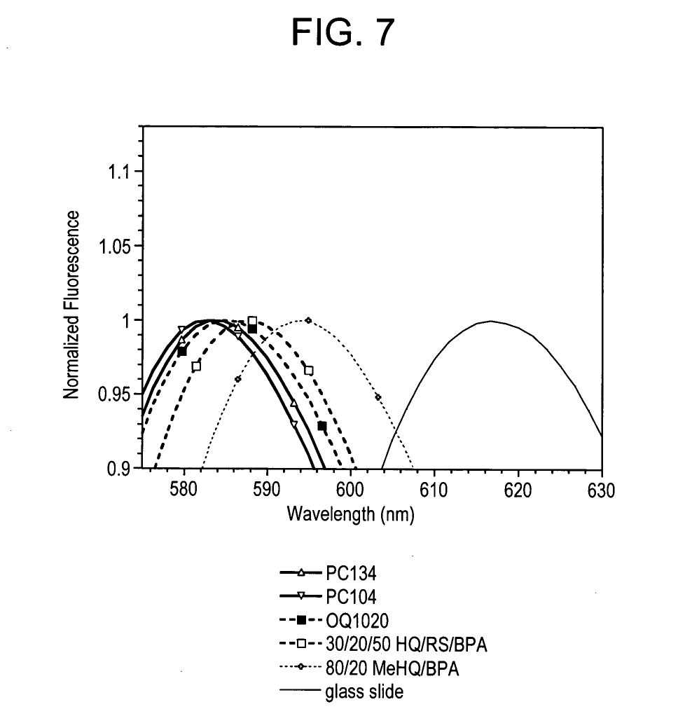

FIGS. 5-7, the spectra of nile red obtained for these treated substrates, demonstrate the effects of the solvent on different types of polycarbonate copolymer substrates with different molecular weights (the glass slide was used as control). Material E (80/20 MeHQ/BPA) had the best solvent resistance out of the polymers shown in Table 2 as demonstrated by the fact that the fluorescence spectrum of nile red region deposited onto material E was closest to the spectrum of nile red on a totally inert substrate (i.e., the glass slide).

Sensors possessing the second type of sensor regions (bromocresol green in cellulose acetate) were tested to determine their response to pH, which was adjusted with NaOH or HCl to a level of interest when deposited onto different substrates. Upon rapid exposure to a solvent THF containing bromocresol green and cellulose acetate, a polycarbonate copolymer lacking solvent resistance was attacked by the solvent and the components of the solution were partially incorporated into the polymer. However, a polycarbonate copolymer with high solvent resistance was not dissolved by the solvent and components of the solution were barely incorporated into the polymer. By comparing the response of the sensor regions to analyte after solvent evaporation, it was possible to qualitatively determine the level of solvent-induced degradation of the polymer, which will affect sensor performance.

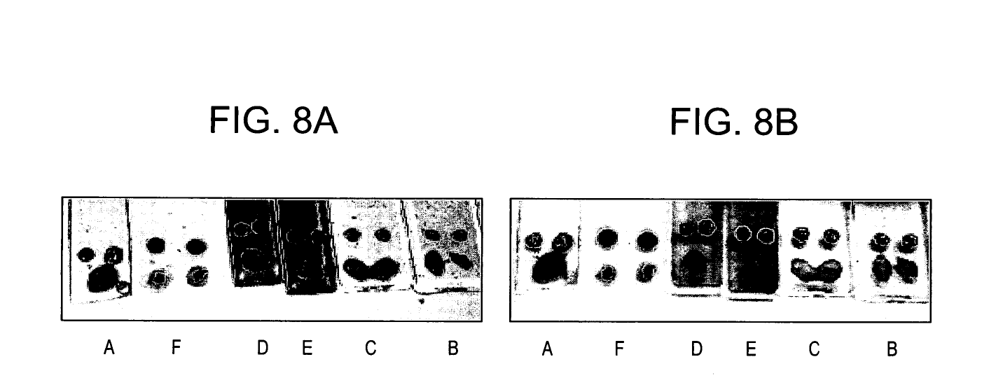

FIG. 8 contains photographs demonstrating the effects of the solvent on different types of polycarbonate copolymer substrates with different molecular weights (the glass slide was used as control) under both low pH (pH=3) (FIG. 8(1)) and high pH (pH=10) (FIG. 8(2)) conditions. As can be seen in FIG. 8 (2), material E (80/20 MeHQ/BPA) once again had the best solvent resistance out of the polymers shown in Table 2 as demonstrated by the fact that the response to the analyte (high pH) of the sensor region deposited onto material E was closest to the response of the control (inert glass slide). The response was indicated by the color change from yellow to blue upon increase of pH from 3 to 10. As expected, the sensor regions on the glass slide (material F) changed color upon an increase of pH because the glass substrate did not interfere with the cellulose acetate film. However, sensor regions on material A did not appreciably change color. Similarly, only a negligible change in color was observed in sensor regions deposited onto materials B, C, and D. The biggest color change was observed with sensor regions deposited onto material E.

### EXAMPLE 3

This experiment analyzed applications of polycarbonate copolymers as sensor substrates. Quantitative detection of chemical species using advanced polymeric substrates was achieved with an optical-based sensor system. The system, described above in Example 2, contained a portable white light source, a spectrometer, and a bifurcated fiber-optic bundle.

Detection of pH was performed by dissolving cellulose acetate and bromothymol blue in methyl ethyl ketone (MEK) and depositing the solution of this polymer and reagent onto a surface of an Izod bar made from material #2 (see Table 1 above). The film was produced by evaporation of the solvent at room temperature for several hours followed by baking at 80° C. for one hour. The Izod bar with a deposited sensor region was then immersed in a solution having varying levels of pH adjusted with NaOH or HCl with concentrations produced by adding known amounts of stock solutions of analyte. pH was adjusted by adding dropwise 100 microliters of a stock solution of pH (2 or 14) to the sample solution.

Measurements of absorbance spectra were performed using a modular automatic scanning system that consisted of a white light source and a portable spectrofluorometer. The light from the light source (Ocean Optics, Inc., Model LS-1) was focused into one of the arms of a “six-around-one” bifurcated fiber-optic reflection probe (Ocean Optics, Inc., Model R400-7-UV/VIS). Light was brought through the common end of the fiber-optic probe to a sample and reflected light was collected. The second arm of the probe was coupled to the portable spectrofluorometer (Ocean Optics, Inc., Model ST2000) through an in-line optical filter holder (Ocean Optics). The spectrofluorometer was equipped with a 200-μm slit, 600-grooves/mm grating blazed at 400 nm and covering the spectral range from 250 to 800 nm with efficiency greater than 30%, and a linear CCD-array detector. Spectrofluorometer converted spectra into absorbance spectra. Data analysis was performed using KaleidaGraph software (Synergy Software, Reading, Pa.).

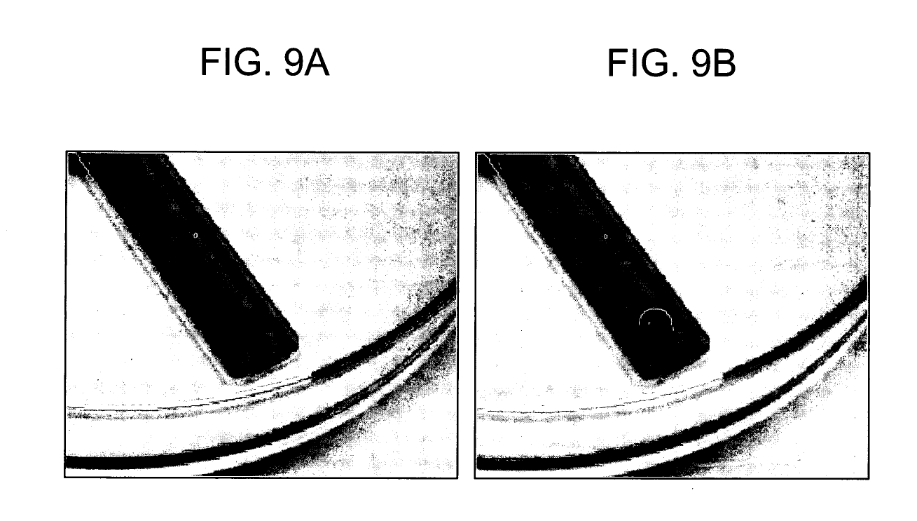

FIG. 9 illustrates the results of these tests. Inspection of the immobilized dye in solutions of low (pH=3, FIG. 9A) and high (pH=10, FIG. 9B) pH demonstrated two important aspects of the sensor substrates. First, the sensor region deposited using an organic solvent (MEK) did not degrade the sensor substrate. Second, the immobilized reagent exhibited preserved analyte-sensitive properties.

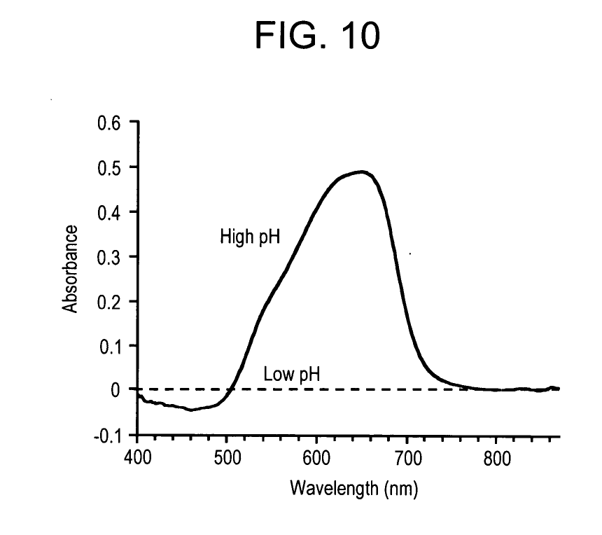

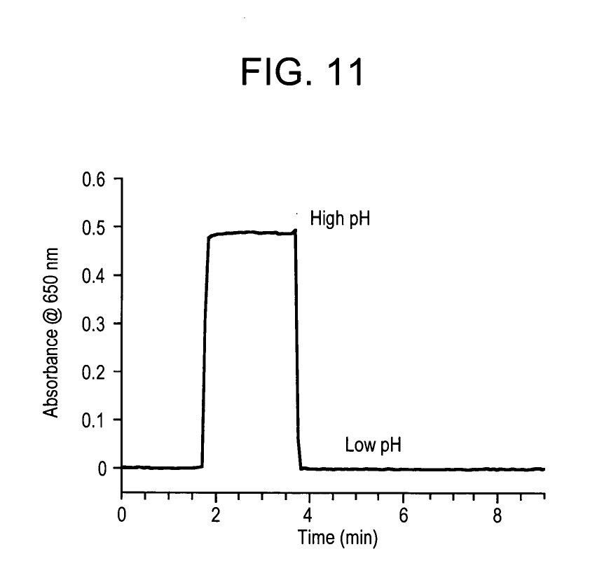

Spectral properties of the immobilized reagent were investigated by taking an absorbance of the reagent in low-pH solution as a baseline and measuring the change in absorbance of the reagent upon an increase in pH. The spectral results are presented in FIG. 10. Stability of the immobilized reagent in solutions of low and high pH over the relevant time of measurement is set forth in FIG. 11.

### EXAMPLE 4

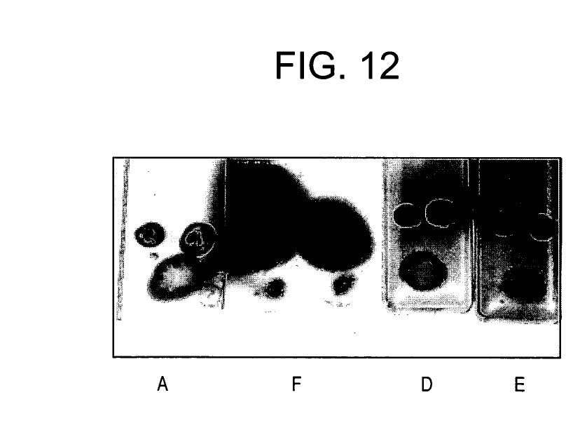

This example compared the long term stability of sensor regions on some of the different substrates set forth in Example 2 above (see FIG. 12 and Table 2 above). Sensor regions were deposited on substrates as described above in Example 2 and then exposed to high pH (pH=10) for an extended period of time. The results of this experiment for the substrates tested are set forth in FIG. 12. As FIG. 12 demonstrates, the inert substrate (material F, see Table 2) does not provide as much stability as materials D or E. This additional improvement in the long term stability is provided by the small interfacial diffusion that takes place between the sensor region and the substrate. As expected, conventional polycarbonate materials also show good long term stability of the sensor regions (see, e.g., material A) however, the response of the sensor regions on these materials was unacceptably slow.

### EXAMPLE 5

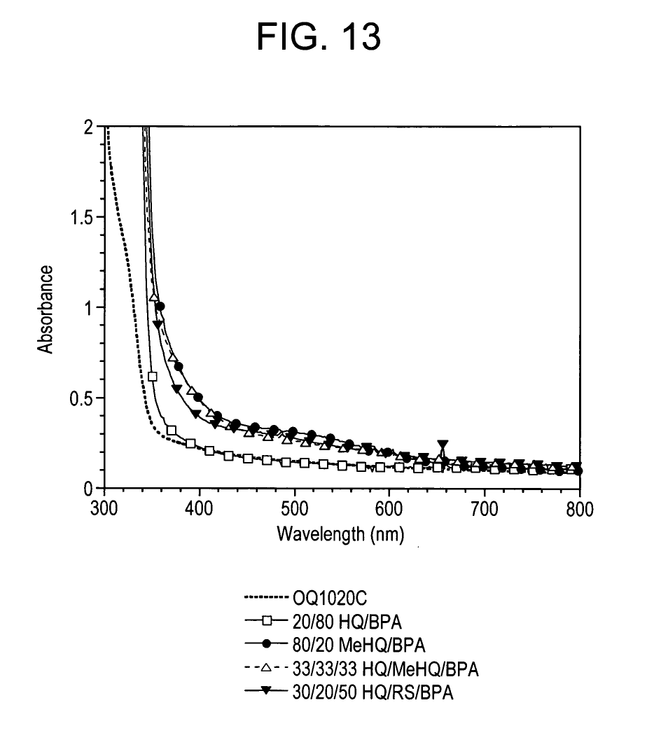

This example examined the spectroscopic properties of polymers. The optical properties of the polycarbonate copolymer materials were investigated in order to ensure that the different optical features of the copolymers did not negatively affect the sensor system performance. The system utilized in these tests is described above in Example 3. Copolymers were made as Izod bars with thicknesses of ⅛ inch. The UV-visible spectra obtained, which are set forth in FIG. 13, demonstrate that the electronic absorption spectra of the copolymers did not significantly differ from the spectra of a control material such as polycarbonate optical grade OQ1020C in the spectral range of interest for optical detection.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

1. A sensor device comprising:
a substrate comprising a polycarbonate combined with at least one solvent resistance-imparting monomer; and
a sensor region comprising an analyte-responsive reagent having a predetermined response upon exposure to an analyte of interest.

2. The sensor device of claim 1 wherein the polycarbonate comprises structural units of the formula: 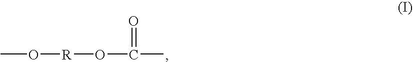
wherein at least about 60% of the total number of R groups are aromatic organic radicals and the balance thereof are aliphatic, alicyclic, or aromatic radicals.

3. The sensor device of claim 2 wherein R comprises an aromatic organic radical of the formula:
-A1-Y-A2- (II)
wherein each A¹ and A² is a monocyclic divalent aryl radical and Y is a bridging radical in which one or two carbon atoms separate A¹ and A².

4. The sensor device of claim 1 wherein the polycarbonate comprises 2,2-bis(4-hydroxyphenyl)propane.

5. The sensor device of claim 1 wherein the at least one solvent resistance-imparting monomer is selected from the group consisting of hydroquinone, resorcinol, 3-methylhydroquinone, 3-ethylhydroquinone, 3-propylhydroquinone, 3-butylhydroquinone, 3-t-butylhydroquinone, 3-phenylhydroquinone, 3-cumylhydroquinone, 2,3,5,6-tetrafluorohydroquinone and 2,3,5,6-tetrabromohydroquinone.

6. The sensor device of claim 1 wherein the amount of solvent resistance-imparting monomer ranges from about 2 to about 90 mol %.

7. The sensor device of claim 1 wherein the analyte-responsive reagent is selected from the group consisting of calorimetric reagents, luminescent reagents, chemiluminescent reagents, Raman reagents, surface-enhancement Raman reagents, vacuum UV absorbance reagents, UV-visible light absorbance reagents, and infrared absorbance reagents.

8. The sensor device of claim 1 wherein the analyte-responsive reagent is selected from the group consisting of organic molecules, inorganic molecules, inorganic nanoparticles, semiconducting nanoparticles, and metallic nanoparticles.

9. The sensor device of claim 1 wherein the sensor region further comprises a support matrix.

10. The sensor device of claim 9 wherein the support matrix is selected from the group consisting of polymers, sol-gels, and biomembranes.

11. The sensor device of claim 1 wherein the sensor device further comprises a protecting layer over the sensor region.

12. The sensor device of claim 11 wherein the protecting layer comprises an amorphous fluoropolymer.

13. The sensor device of claim 11 wherein the protecting layer further comprises a polyimide.

14. The sensor device of claim 11 wherein the protecting layer further comprises a hydrogel.

15. The sensor device of claim 11 wherein the protecting layer further comprises a polymer layer which is inert to both a sample solution and the substrate.

16. The sensor device of claim 1 wherein the sensor region comprises a thin film having a thickness ranging from about 0.001 to about 1000 micrometers.

17. The sensor device of claim 1 wherein the sensor region comprises a thin film having a thickness ranging from about 0.005 to about 500 micrometers.

18. The sensor device of claim 1 wherein the sensor region comprises discrete sensor spots.

19. The sensor device of claim 1 wherein the sensor is selected from the group consisting of optical sensors, acoustic wave sensors, chemical resistors, conductivity sensors, micro-electro-mechanical system sensors, and electrochemical sensors.

20. A sensor device comprising:
a substrate comprising 2,2-bis(4-hydroxyphenyl)propane combined with at least one solvent resistance-imparting monomer selected from the group consisting of hydroquinone, resorcinol, 3-methylhydroquinone, 3-ethylhydroquinone, 3-propylhydroquinone, 3-butylhydroquinone, 3-t-butylhydroquinone, 3-phenylhydroquinone, 3-cumylhydroquinone, 2,3,5,6-tetrafluorohydroquinone and 2,3,5,6-tetrabromohydroquinone; and
a sensor region comprising an analyte-responsive reagent having a predetermined response upon exposure to an analyte of interest.

21. The sensor device of claim 20 wherein the amount of solvent resistance-imparting monomer ranges from about 2 to about 90 mol %.

22. The sensor device of claim 20 wherein the analyte-responsive reagent is selected from the group consisting of colorimetric reagents, luminescent reagents, chemiluminescent reagents, vacuum UV absorbance reagents, UV-visible light absorbance reagents, and infrared absorbance reagents.

23. The sensor device of claim 20 wherein the analyte-responsive reagent is selected from the group consisting of organic molecules, inorganic molecules, inorganic nanoparticles, semiconducting nanoparticles, and metallic nanoparticles.

24. The sensor device of claim 20 wherein the sensor region further comprises a support matrix.

25. The sensor device of claim 24 wherein the support matrix is selected from the group consisting of polymers, sol-gels, and biomembranes.

26. The sensor device of claim 20 wherein the sensor device further comprises a protecting layer over the sensor region.

27. The sensor device of claim 26 wherein the protecting layer comprises an amorphous fluoropolymer.

28. The sensor device of claim 26 wherein the protecting layer further comprises a polyimide.

29. The sensor device of claim 26 wherein the protecting layer further comprises a hydrogel.

30. The sensor device of claim 26 wherein the protecting layer further comprises a polymer layer which is inert to both a sample solution and the substrate.

31. The sensor device of claim 20 wherein the sensor region comprises a thin film having a thickness ranging from about 0.001 to about 1000 micrometers.

32. The sensor device of claim 20 wherein the sensor region comprises a thin film having a thickness ranging from about 0.005 to about 500 micrometers.

33. The sensor device of claim 20 wherein the sensor region comprises discrete sensor spots.

34. The sensor device of claim 20 wherein the sensor is selected from the group consisting of optical sensors, acoustic wave sensors, chemical resistors, conductivity sensors, micro-electro-mechanical system sensors, and electrochemical sensors.
